(19) United States
(12) Patent Application Publication
(10) Pub. No.: US 2006/0202154 A1
(43) Pub. Date: Sep. 14, 2006

(54) Refrigerant mixture and use thereof in air conditioners

(75) Inventors: Felix Flohr, Hildesheim (DE); Christoph Meurer, Hanover (DE); Martin Schwiegel, Hannover (DE); Werner Kruecke, Hannover (DE)

Correspondence Address: CROWELL & MORING LLP;INTELLECTUAL PROPERTY GROUP, P.O. BOX 14300, WASHINGTON, DC, 20044-4300, US

(73) Assignee: Solvay Fluor GmbH, Hannover (DE)

(21) Appl. No.: 11/362,002

(22) Filed: Feb. 27, 2006

Related U.S. Application Data
(63) Continuation of application No. PCT/EP04/08772, filed on Aug. 5, 2004.

(30) Foreign Application Priority Data
Jul. 7, 2004 (DE) 10 2004 032 792.0
Aug. 27, 2003 (DE) 103 39 444.3

(51) Int. Cl. C09K 5/04

(52) U.S. Cl. 252/67

(57) ABSTRACT

A refrigerant mixture that is suitable as a substitute for the refrigerant 1,1,1,2-tetrafluoroethane (R134a) in which the mixture contains or is composed of halogenated hydrocarbons having a GWP₁₀₀ of not more than 150 and carbon dioxide. The refrigerant mixture is suitable for use as a refrigerant in air conditioning systems, especially for automobile air conditioning systems.

### CROSS REFERENCE TO RELATED APPLICATIONS

This application is a continuation of international patent application no. PCT/EP2004/008772, filed Aug. 5, 2004, designating the United States of America, and published in German on Mar. 10, 2005 as WO 2005/021675, the entire disclosure of which is incorporated herein by reference. Priority is claimed based on Federal Republic of Germany patent application nos. DE 103 39 444.3, filed Aug. 27, 2003 and DE 10 2004 032 792.0, filed Jul. 7, 2004.

### BACKGROUND OF THE INVENTION

The present invention relates to a refrigerant mixture, particularly to a refrigerant mixture for air conditioning units for motor vehicles and commercial vehicles, especially for automobile air conditioners.

It is known to use halogenated hydrocarbons or mixtures thereof as refrigerants.

The use of so-called natural refrigerants and especially their use in vehicle air conditioners has been under discussion for some time. Carbon dioxide is a possible replacement material, the direct greenhouse potential of which is negligibly small in comparison to that of previously used, ozone-friendly 1,1,1,2-tetrafluoroethane (R134a). Because it is incombustible, carbon dioxide was used until about 1950 as the refrigerant for refrigerators. However, because of the unfavorable triple point and the unfavorable pressure situation, it has become insignificant as a refrigerant with the advent of fluorochlorohydrocarbons.

It is known to use carbon dioxide as a refrigerant by itself or in admixture with halogenated hydrocarbons.

It is furthermore known that, of the halogenated hydrocarbons, especially the fluorochlorohydrocarbons have a very high greenhouse potential or global warming potential (GWP). On the other hand, the GWP value for partially fluorinated hydrocarbons is clearly lower. A variety of substances, which do not have an ozone decomposition potential, has meanwhile become available in the refrigeration sector.

German patent application no. DE 41 16 274 discloses a refrigerant mixture, which contains carbon dioxide and partially fluorinated hydrocarbons, such as R134a (CF₃—CH₂F) or R152a (CHF2-CH₃). These mixtures are used especially as a replacement for the refrigerant R22 (CHClF₂) and R502 [an azeotropic mixture of CHClF₂ (R22) and C₂ClF₅ (R115)].

Published international patent application no. WO 00/39242 likewise describes a refrigerant mixture as a substitute for R22 (CHClF₂) or R502 (mixture of CHClF₂ and C₂ClF₅). This mixture is composed of fluoroethane (R161) and trifluoroiodomethane (R13I1).

### SUMMARY OF THE INVENTION

It is an object of the invention to provide a refrigerant mixture which may be used as a replacement for R134a.

Another object is to provide a refrigerant mixture which has a low greenhouse potential, is non-toxic and, as far as possible, is not combustible.

These and other objects of the invention are achieved in accordance with the present invention by providing a refrigerant mixture usable as a replacement for 1,1,1,2-tetrafluoroethane (R134a) comprising at least one halogenated hydrocarbon having a greenhouse potential (GWP₁₀₀) of less than 150 and carbon dioxide.

In accordance with a further aspect of the invention, the objects are achieved by providing a refrigeration system comprising a refrigerant which comprises at least one halogenated hydrocarbon having a greenhouse potential (GWP₁₀₀) of less than 150 and carbon dioxide.

### BRIEF DESCRIPTION OF THE DRAWING

The accompanying drawing FIGURE is a graph of the lower explosion limit expressed in volume percent in air for a refrigerant consisting of a mixture of R152a and carbon dioxide plotted verses the proportion of carbon dioxide in the refrigerant mixture in weight percent.

### DESCRIPTION OF THE INVENTION

The refrigerant mixture of the invention contains or consists of halogenated hydrocarbons with a GWP₁₀₀ of less than 150 and carbon dioxide.

Halogenated hydrocarbons with a GWP₁₀₀ of less than 150, which are suitable as compounds which can be used in combination with carbon dioxide as a replacement for the refrigerant 1,1,1,2-tetrafluoroethane (R134a), include in particular 1,1-diffluoroethane (R152a), fluoroethane (R161) and trifluoroiodomethane (R13I1).

As individual substances, fluoroethane and difluoroethane are combustible. However, they have a GWP₁₀₀ of less than 150 and are very unstable in the atmosphere. Thus, fluoroethane has a GWP₁₀₀ of 12, and difluoroethane has a GWP₁₀₀ of 120.

Trifluoroiodomethane is not combustible. However, it is also very unstable in the atmosphere. It has been found that the disadvantageous properties of the individual substances could be compensated for or offset by combining them with carbon dioxide and that the resulting refrigerant mixture according to the invention could be used especially for automobile air conditioners. With respect to their direct greenhouse potential, these refrigerant mixtures are significantly more advantageous than 1,1,1,2-tetrafluoroethane and can therefore be used as a replacement material. The composition of the refrigerant mixture can be varied as a function of the pressure in the refrigeration system.

It is also within the scope of the invention to select the composition of the refrigerant mixture so that the risk of combustibility is minimized or greatly limited.

In one embodiment, a mixture of 98 to 70% by weight of R152a and 2 to 30% by weight of carbon dioxide is used as replacement for R134a.

As pure substances, the two individual components of the mixture according to the invention have disadvantages when used as refrigerants.

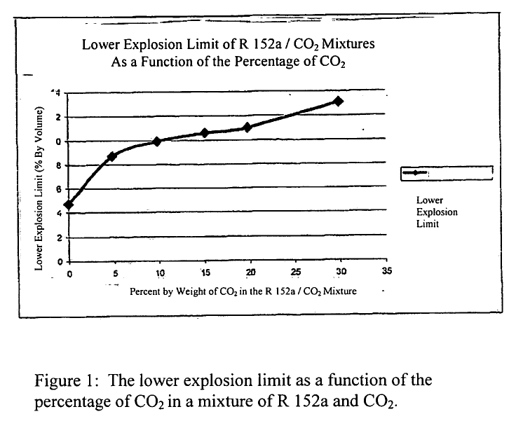

R152a behaves similarly to R134a from the point of view of its thermophysical properties. However, because of its combustibility, the use of R152a in direct evaporation systems, such as automobiles, is limited. The explosion range of R152a lies between a lower explosion limit of 4.5% by volume and an upper explosion limit of 21.8% by volume. For mixtures containing 30% by weight of carbon dioxide, the explosion limit increases to 13% by volume (refer to FIG. 1). The increase in the lower explosion limit reduces the risk, which generally exists with combustible refrigerants.

The thermophysical properties of carbon dioxide are very different from those of R134a and R152a. Carbon dioxide is not combustible and has a much higher vapor pressure than R134a or R152a.

| | Bubble Point Pressure | |
|---|---|---|
| Refrigerant | at 0° C. (bar) | T_{crit} (° C.) |
| CO₂ | 34.9 | 31.1 |
| R134a | 2.9 | 101.5 |
| R152a | 2.6 | 113 |

As a result of its critical temperature of 31° C., carbon dioxide cannot be used for air-conditioning vehicles in the classical, sub-critical compression refrigeration process and, instead, must pass through a trans-critical process. Essentially, the trans-critical process leads to a significantly higher operating pressures (>100 bar) and to a clear deterioration in the theoretically attainable maximum efficiency.

Although it is produced by the human body, carbon dioxide has a toxic effect at concentrations above 4% by volume and, when breathed for a prolonged period, can lead to unconsciousness and, at concentrations above 8% by volume, to death. This toxicity effect is eliminated in mixtures with R152a.

R134a, with a GWP₁₀₀ of 1300, makes a relatively high contribution to the greenhouse effect if it reaches the atmosphere. With a GWP₁₀₀ of 140 for R152a and of 1 for carbon dioxide, the components, used pursuant to the invention, have a significantly lower GWP₁₀₀ than R134a.

Because the specific densities of R152a and carbon dioxide are different from those of R134a, the amount required to fill an automobile air conditioner can be reduced significantly (see Table 1). In the table, it is assumed that a cooler is used which has ⅓ of the total refrigerant volume in the condensed state; leaving ⅔ of the total refrigerant volume in the gaseous state.

TABLE 1
Comparison of amounts required to fill air conditioner

| | |
|---|---|
| R134a | R152a |

| | | | | |
|---|---|---|---|---|
| rho′ (T = 45° C.) | 1125 | kg/m² | 845 | kg/m² |
| rho″ (T = 0° C.) | 14.43 | kg/m² | 8.39 | kg/m² |
| m′ (V′ = ⅓Vₜₒₜₐₗ) | 375 | kg | 282 | Kg |
| m″ (V″ = ⅔Vₜₒₜₐₗ) | 9.62 | kg | 5.60 | Kg |
| mₜₒₜₐₗ | 384.62 | kg | 287.60 | Kg |

| | | |
|---|---|---|
| mₜₒₜₐₗ/mₜₒₜₐₗ R134a | 1 | 0.75 |

rho = density;
m = mass;
V = volume;
′= liquid state;
″= gaseous state

It was found that the mixture has a high volumetric refrigeration capacity. This high refrigeration capacity leads to a decrease in the required displacement or compression volume of the compressor and thus to a decrease in the structural size of the compressor (see Example 1).

Higher cooling rates are attained, if compressors are employed, which were intended to be used with R134a,. This is of decisive importance for automobile air conditioners for various reasons, not least of which is safety.

Mixtures of R152a and carbon dioxide containing more than 2% by weight of carbon dioxide have a higher vapor pressure than R134a. Higher vapor pressures improve the heat transfer and reduce frictional losses. Both effects positively affect the energy efficiency of the overall system.

Mixtures of R152a and carbon dioxide exhibit a large temperature glide. This has a positive effect if heating and cooling at gliding temperatures is necessary. A sliding heat transfer occurs whenever there is no phase change on the secondary side and thus also during cooling or heating of air.

### EXAMPLE: 1

The refrigerant or refrigerant mixture was compared with each other in a simulated automobile air conditioner under the conditions given below.

Circulation Conditions

Simple circulation with internal heat exchanger
Tu=30° C.
To=0° C.
Tc=45° C.
T overheated=5° K
T undercooled 2° K
isotropic efficiency=1
ΔT_{IWT}=12° K
   Deviating Conditions for the Zeotropic Mixtures of R152a and Carbon Dioxide

Heat transfer in the heat exchanger takes place at an average temperature of
Tₘ=T′−(T″−T′)/2
Deviating Conditions For The 79.3 2/20.68 Weight Percent Mixture of R152a And Carbon Dioxide

The outlet temperature of the refrigerant was set at 35° C., which leads to an average Tₘ of 48.5° C.

Diviating conditions for the trans-critical carbon dioxide process:
ΔT_{IWT}=5° K

TABLE 2
Comparison of the Coefficient of Performance (COP) and the
Volumetric Refrigeration Capacity of Different Refrigerants

| Percentage by | Percentage by | Percentage by | | |
|---|---|---|---|---|
| weight of | weight of | weight of | | Qvol |
| R134a | R152a | carbon dioxide | COP | (kJ/m²) |
| 100 | 0 | 0 | 5.00 | 2089 |
| 0 | 100 | 0 | 5.04 | 1932 |
| 0 | 0 | 100 | 2.70 | 9786 |
| 0 | 90.06 | 9.94 | 5.76 | 3333 |
| 0 | 79.32 | 20.68 | 5.27 | 4443 |

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A refrigerant mixture usable as a replacement for 1,1,1,2-tetrafluoroethane (R134a) comprising at least one halogenated hydrocarbon having a greenhouse potential (GWP₁₀₀) of less than 150 and carbon dioxide.

2. A refrigerant mixture according to claim 1, wherein said at least one halogenated hydrocarbon is selected from the group consisting of 1,1-difluoroethane, fluoroethane and trifluoroiodomethane.

3. A refrigerant mixture according to claim 1, wherein said mixture consists of a halogenated hydrocarbon having a greenhouse potential (GWP₁₀₀) of less than 150 and carbon dioxide.

4. A refrigerant mixture according to claim 2, consisting of 98 to 70% by weight of 1,1-difluoroethane and to 2 to 30% by weight of carbon dioxide.

5. A refrigerant mixture according to claim 1, comprising fluoroethane and carbon dioxide.

6. A refrigerant mixture according to claim 5, wherein said mixture consists of fluoroethane and carbon dioxide.

7. In a refrigeration system, the improvement comprising a refrigerant comprising at least one halogenated hydrocarbon having a greenhouse potential (GWP₁₀₀) of less than 150 and carbon dioxide.

8. A refrigeration system according to claim 7, wherein said refrigeration system is an air conditioning system.

9. A refrigeration system according to claim 8, wherein said air conditioning system is an automobile air conditioning system.

10. A refrigeration system according to claim 7, wherein said refrigerant is a replacement for 1,1,1,2-tetrafluoroethane (R134a).

11. A refrigeration system according to claim 7, wherein said refrigerant consists of 98 to 70% by weight of R152a and 2 to 30% by weight of carbon dioxide.

12. A refrigeration system according to claim 7, wherein said refrigerant comprises fluoroethane and carbon dioxide.

13. A refrigeration system according to claim 12, wherein said refrigerant consists of fluoroethane and carbon dioxide.
